(19) United States
(12) Patent Application Publication
(10) Pub. No.: US 2014/0055868 A1
(43) Pub. Date: Feb. 27, 2014

(54) Plastic Lens with Improved Eccentricity and Method for Manufacturing the Same

(71) Applicant: GENIUS ELECTRONIC OPTICAL CO., LTD., Taichung City (TW)

(72) Inventors: Yu-Lin Hsieh, Taichung City (TW); Fu-Chin Chen, Taichung City (TW)

(73) Assignee: GENIUS ELECTRONIC OPTICAL CO., LTD., Taichung City (TW)

(21) Appl. No.: 13/762,618

(22) Filed: Feb. 8, 2013

(30) Foreign Application Priority Data
Aug. 24, 2012 (CN) 201210304536.3

(51) Int. Cl. G02B 3/00

(52) U.S. Cl. CPC G02B 3/00
USPC 359/642; 264/1.1; 264/2.2

(57) ABSTRACT

A plastic lens includes: a lens body which has a first surface, a second surface opposite to the first surface, a circumferential surface interconnecting the first surface and the second surface, and a central optical axis along which the first and second surfaces are arranged, the first surface having a curved surface portion and a stepped surface portion surrounding the curved surface portion; a first flash that is located at the stepped surface portion and that surrounds the central optical axis; and a second flash that is located at the stepped surface portion and that surrounds the first flash.

### CROSS-REFERENCE TO RELATED APPLICATION

This application claims priority of Chinese Application No. 201210304536.3, filed on Aug. 24, 2012.

### BACKGROUND OF THE INVENTION

1. Field of the Invention

This invention relates to a plastic lens and a method for manufacturing the same.

2. Description of the Related Art

An injection mold assembly used to manufacture a plastic lens generally includes a first base mold, a first core mold disposed in the first base mold, a second base mold disposed relative to the first base mold, and a second core mold disposed in the second base mold. The first base mold, the second base mold, the first core mold, and the second core mold cooperatively define a cavity. A molten plastic material is injected into the cavity followed by cooling to form a plastic lens. The second base mold and the second core mold together with the plastic lens are moved away from the first base mold and the first core mold. The second core mold then pushes the plastic lens out of the second base mold. Afterwards, the second base mold and the second core mold return to their initial positions for another injection molding process.

In order to allow the second core mold to smoothly move relative to the second base mold, there must be a gap between the second base mold and the second core mold. However, the gap may cause the second core mold to have a radial displacement relative to the second base mold, which may result in eccentricity of the resultant plastic lens. Furthermore, the second core mold may also have axial displacement against the second base mold which might result in a thicker or thinner plastic lens. The two scenarios mentioned above would adversely affect optical properties of the plastic lens.

### SUMMARY OF THE INVENTION

Therefore, the object of this invention is to provide a plastic lens with improved eccentricity and a method for manufacturing the same.

According to a first aspect of this invention, there is provided a plastic lens having a lens body, a first flash, and a second flash. The lens body has a first surface, a second surface opposite to the first surface, a circumferential surface interconnecting the first surface and the second surface, and a central optical axis along which the first and second surfaces are arranged. The first surface has a curved surface portion and a stepped surface portion surrounding the curved surface portion. The central optical axis perpendicularly passes through center of the curved surface portion. The first flash is located at the stepped surface portion and surrounds the central optical axis. The second flash is located at the stepped surface portion and surrounds the first flash.

According to a second aspect of this invention, there is provided a method for manufacturing a plastic lens with improved eccentricity. The method includes the following steps:

(a) providing a mold assembly which includes a first mold, a second mold, and an ejector, the first mold including a first base mold and a first core mold disposed in the first base mold, the second mold including a second base mold and a second core mold disposed in the second base mold, the ejector being disposed between the second base mold and the second core mold and surrounding the second core mold, the first base mold, the first core mold, the second base mold, the second core mold, and the ejector cooperatively defining a cavity;

(b) injecting a molten plastic material into the cavity followed by cooling so as to form the plastic lens;

(c) removing the first mold from an assembly of the plastic lens, the second mold, and the ejector; and

(d) moving the ejector relative to the second mold to move the plastic lens away from the second mold while maintaining the second core mold immobilized.

### BRIEF DESCRIPTION OF THE DRAWINGS

Other features and advantages of the present invention will become apparent in the following detailed description of the preferred embodiments with reference to the accompanying drawings. It should be noted that the drawings are only for illustrative purpose. This invention should not be limited to any dimension and size shown in the drawings.

FIG. 1 is a perspective view of the preferred embodiment of a plastic lens with improved eccentricity according to this invention.

FIG. 2 is a cross sectional view of the preferred embodiment.

FIG. 3 is a fragmentary schematic top view of the plastic lens showing surface textures.

FIG. 4 is a sectional view showing the preferred embodiment of the plastic lens installed in an electrical device.

FIG. 5 is a fragmentary cross sectional view illustrating the preferred embodiment of a method for manufacturing a plastic lens according to this invention, in which a mold assembly used in this preferred embodiment is shown.

FIG. 6 is a fragmentary cross sectional view illustrating a step of ejecting the plastic lens using an ejector of the preferred embodiment of the method of this invention.

FIG. 7 is a flow chart showing the preferred embodiment of the method according to this invention.

### DETAILED DESCRIPTION OF THE PREFERRED EMBODIMENTS

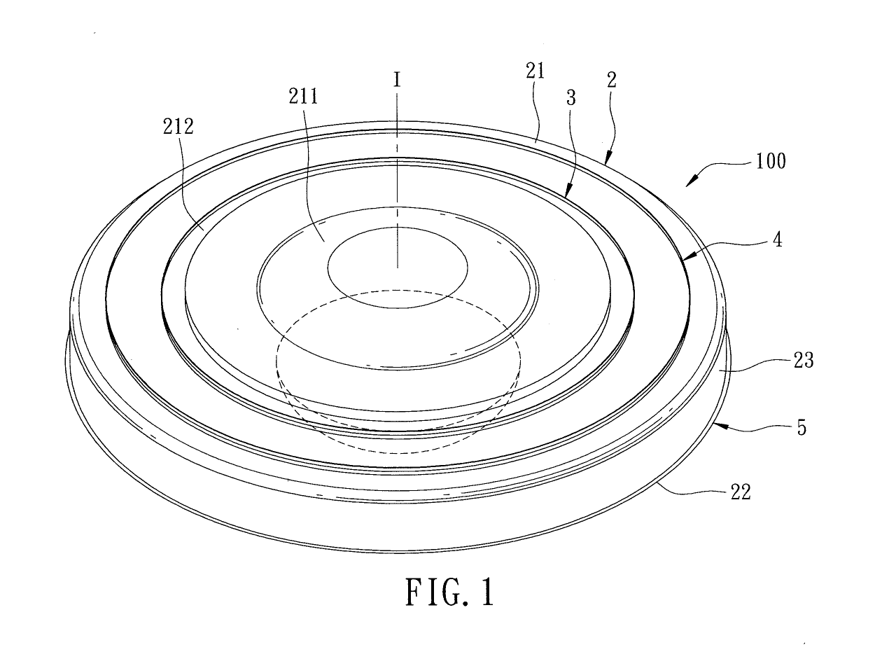

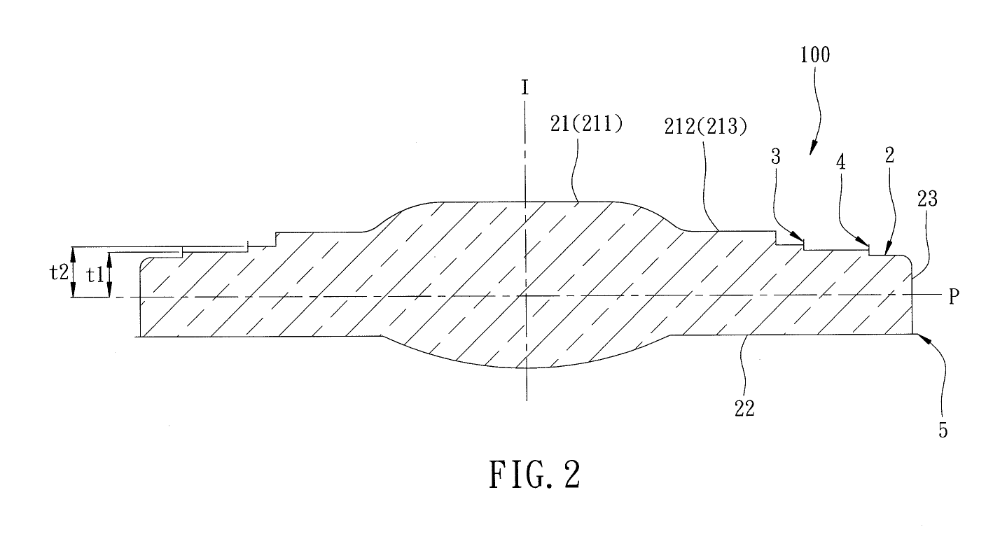

FIGS. 1 and 2 illustrate the preferred embodiment of a plastic lens 100 with improved eccentricity according to this invention. The plastic lens 100 has a lens body 2, a first flash 3, a second flash 4, and a third flash 5.

The lens body 2 has a first surface 21, a second surface 22 opposite to the first surface 21, a circumferential surface 23 interconnecting the first surface 21 and the second surface 22, and a central optical axis (I) along which the first and second surfaces 21, 22 are arranged. The first surface 21 has a curved surface portion 211 and a stepped surface portion 212 surrounding the curved surface portion 211. The central optical axis (I) perpendicularly passes through center of the curved surface portion 211 of the first surface 21.

The first flash 3 is located at the stepped surface portion 212 and surrounds the central optical axis (I).

The second flash 4 is located at the stepped surface portion 212 and surrounds the first flash 3.

The third flash 5 is located between the circumferential surface 23 and the second surface 22.

In this embodiment, the second flash 4 concentrically surrounds the first flash 3. A distance between the first flash 3 and the second flash 4 is 0.22 mm. However, in practice, the distance between the first flash 3 and the second flash 4 could range from 0.15 mm to 0.30 mm, and preferably, from 0.20 mm to 0.25 mm, and is not limited to 0.22 mm.

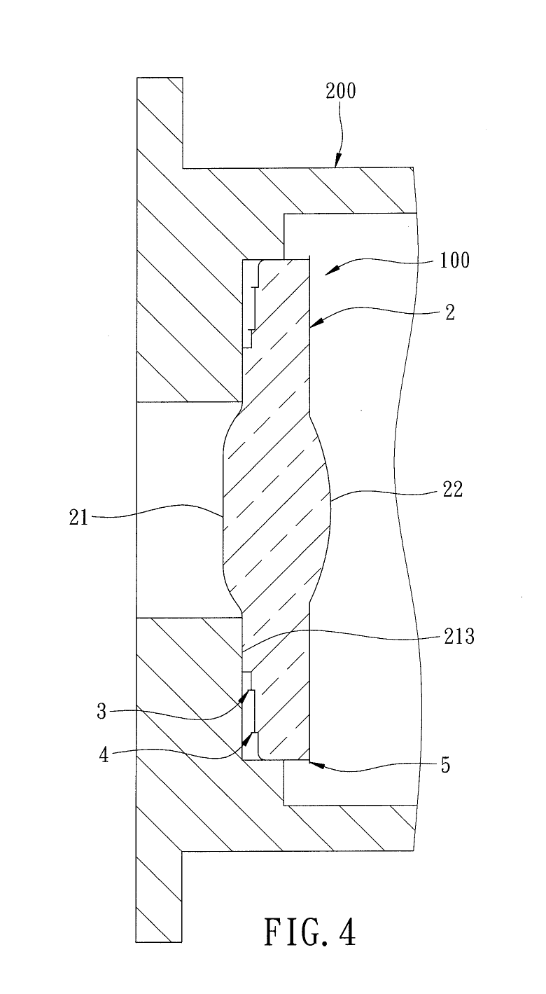

The plastic lens 100 of this invention has an imaginary plane (P) that is defined to be perpendicular to the central optical axis (I) and to be located between the first and second surfaces 21, 22. A distance (t1) from the stepped surface portion 212 between the first and second flashes 3, 4 to the imaginary plane (P) is smaller than a distance (t2) from the stepped surface portion 212 between the first flash 3 and the curved surface portion 211 to the imaginary plane (P). The stepped surface portion 212 between the first flash 3 and the curved surface portion 211 further has an abutment surface 213. A distance from the abutment surface 213 to the imaginary plane (P) is larger than both a distance from the first flash 3 to the imaginary plane (P) and a distance from the second flash 4 to the imaginary plane (P). In such design, when the plastic lens 100 is assembled into an electrical device 200 by abutting the abutment surface 213 against an ambient element of the electrical device 200, the assembly will not be adversely affected by the first and second flashes 3, 4 (see FIG. 4).

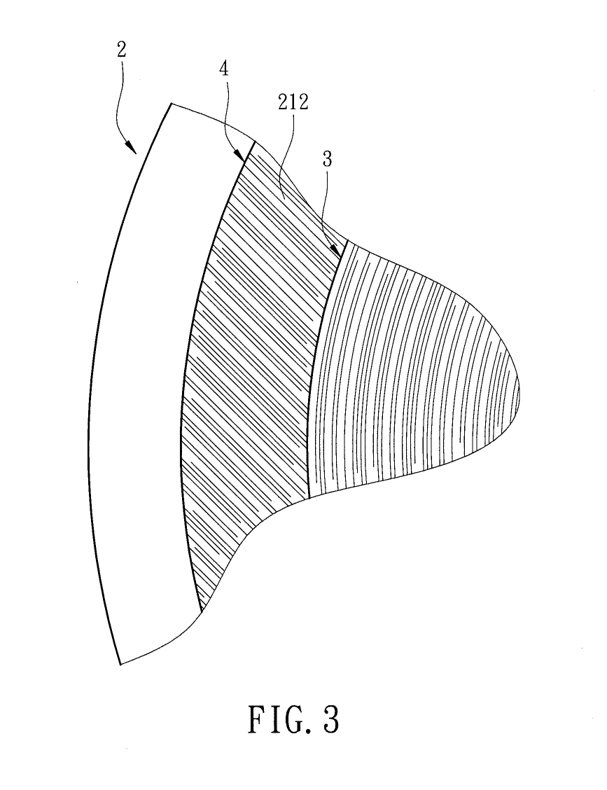

Referring to FIG. 3, the stepped surface portion 212 between the first and second flashes 3, 4 has parallel surface textures. The curved surface portion 211 surrounded by the first flash 3 has concentric surface textures.

FIG. 4 shows the plastic lens 100 being installed in the electrical device 200, in which the abutment surface 213 abuts against the ambient element of the electrical device 200. The first surface 21 faces an image capturing direction. Meanwhile, the first flash 3, the second flash 4, and the third flash 5 will not influence installation of the plastic lens 100.

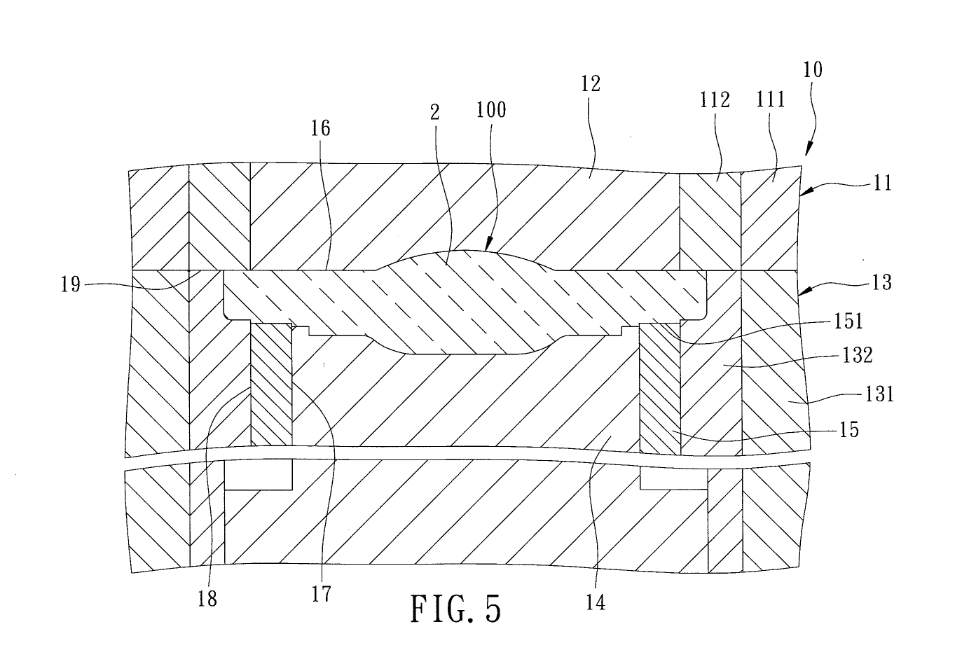

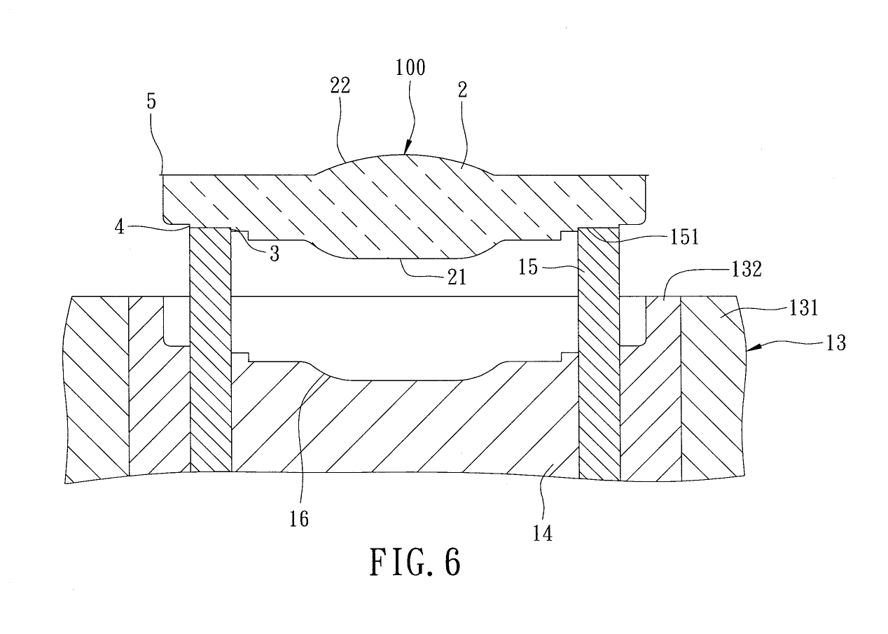

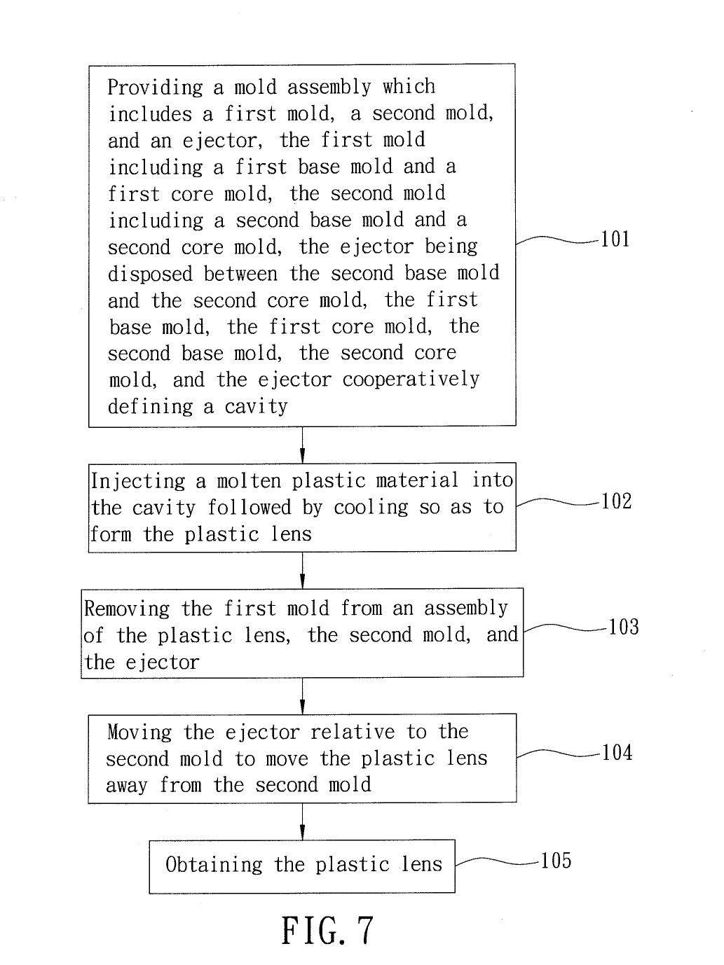

FIGS. 5, 6, and 7 illustrate the preferred embodiment of a method for manufacturing the plastic lens 100 with improved eccentricity. The method includes the following steps: providing a mold assembly (step 101), injecting a molten plastic material (step 102), removing a first mold of the mold assembly (step 103), moving an ejector of the mold assembly to eject a plastic lens (step 104), and obtaining the plastic lens (step 105).

In step 101, the mold assembly 10 includes a first mold 11, a second mold 13, and an ejector 15. The first mold 11 includes a first base mold 111 and a first core mold 12 disposed in the first base mold 111. The first base mold 111 includes a first sleeve 112. The second mold 13 includes a second base mold 131 and a second core mold 14 disposed in the second based mold 131. The second base mold 131 includes a second sleeve 132. The ejector 15 is disposed between the second core mold 14 and the second sleeve 132, and surrounds the second core mold 14. The ejector 15 has a tubular shape. In this embodiment, the first sleeve 112, the first core mold 12, the second sleeve 132, the second core mold 14, and the ejector 15 cooperatively define a cavity 16. The ejector 15 has a top end 151 facing the cavity 16. There are a first gap 17 between the second core mold 14 and the ejector 15, a second gap 18 between the ejector 15 and the second sleeve 132, and a third gap 19 between the first sleeve 112 and the second sleeve 132. Surfaces of the first core mold 12 and the second core mold 14 that face the cavity 16 are subjected to turning operation so that the surfaces are formed with concentric surface textures. A surface of the top end 151 of the ejector 15 facing the cavity 16 is subjected to plane grinding so that the surface of the top end 151 is formed with parallel surface textures. The textures are then printed onto the surface of the plastic lens 100. That is, the stepped surface portion 212 between the first and second flashes 3, 4 has parallel surface textures, and the curved surface portion 211 surrounded by the first flash 3 has concentric surface textures.

In step 102, a molten plastic material is injected into the cavity 16 followed by cooling so as to form the plastic lens 100.

In step 103, the first mold 11 is removed from an assembly of the plastic lens 100, the second mold 13, and the ejector 15.

In step 104, the ejector 15 is moved relative to the second mold 13 to move the plastic lens 100 away from the second mold 13 so as to release therefrom. In this step, the second core mold 14 is kept immobilized.

In step 105, the plastic lens 100 is taken out from the ejector 15.

In step 102, when the molten plastic material is injected into the cavity 16, a small amount of the molten plastic material will flow into the first gap 17, the second gap 18, and the third gap 19 so as to form the first flash 3, the second flash 4, and the third flash 5, respectively, after the molten plastic material is cooled. The second surface 22 of the plastic lens 100 is formed by the first core mold 12 and the first sleeve 112 of the mold assembly 10. The second core mold 14 has a concave surface to form the curved surface portion 211 of the plastic lens 100. The stepped surface portion 212 of the plastic lens 100 is formed by the second core mold 14, the top end 151 of the ejector 15 and the second sleeve 132.

Moreover, the top end 151 of the ejector 15 has a thickness between an outer surface which contacts with the second sleeve 132 of the second base mold 131 and an inner surface which contacts with the second core mold 14. Preferably, the thickness of the top end 151 of the ejector 15 ranges from 0.15 mm to 0.3 mm, more preferably from 0.20 mm to 0.25 mm. The thickness range for the top end 151 of the ejector 15 is designed in consideration of manufacture, assembly, and occupied space of the ejector 15. In this preferred embodiment, the width of the top end 151 is 0.22 mm. In addition, the width of the top end 151 equals the distance between the first flash 3 and the second flash 4.

It is worth mentioning that, in practice, the first and second sleeves 112, 132 can be dispensed with in other embodiments.

In the method of manufacturing the plastic lens 100 of this invention, the ejector 15 is used to move the plastic lens 100 away from the second mold 13. The second core mold 14 does not need to move relative to the second sleeve 132 or the second base mold 131. Therefore, a radial displacement of the second core mold 14 in the second base mold 131 which causes eccentricity of the plastic lens 100 can be prevented, thereby accurately forming the curved surface portion 211 of the plastic lens 100 in a desirable position and providing superior optical properties.

While the present invention has been described in connection with what are considered the most practical embodiments; it is understood that this invention is not limited to the disclosed embodiments but is intended to cover various arrangements included within the spirit and scope of the broadest interpretation so as to encompass all such modifications and equivalent arrangements.

What is claimed is:

1. A plastic lens with improved eccentricity, comprising:
a lens body which has a first surface, a second surface opposite to said first surface, a circumferential surface interconnecting said first surface and said second surface, and a central optical axis along which said first and second surfaces are arranged, said first surface having a curved surface portion and a stepped surface portion surrounding said curved surface portion, the central optical axis perpendicularly passes through center of said curved surface portion;
a first flash that is located at said stepped surface portion and that surrounds the central optical axis; and
a second flash that is located at said stepped surface portion and that surrounds said first flash.

2. The plastic lens of claim 1, wherein said second flash concentrically surrounds said first flash, a distance between said first flash and said second flash ranging from 0.15 mm to 0.3 mm.

3. The plastic lens of claim 2, wherein the distance between said first flash and said second flash ranges from 0.20 mm to 0.25 mm.

4. The plastic lens of claim 1, further comprising a third flash located between said circumferential surface and said second surface.

5. The plastic lens of claim 1, further having an imaginary plane that is perpendicular to the central optical axis and that is located between said first and second surfaces, a distance from said stepped surface portion between said first and second flashes to the imaginary plane being smaller than a distance from said stepped surface portion between said first flash and said curved surface portion to the imaginary plane.

6. The plastic lens of claim 5, wherein said stepped surface between said first flash and said curved surface further has an abutment surface, a distance from said abutment surface to the imaginary plane being larger than both a distance from said first flash to the imaginary plane and a distance from said second flash to the imaginary plane.

7. The plastic lens of claim 1, wherein said stepped surface portion between said first and second flashes has parallel surface textures.

8. The plastic lens of claim 1, wherein said first surface faces an image capturing direction when said plastic lens is installed in an electrical device.

9. A method for manufacturing a plastic lens of claim 1, comprising the following steps:
(a) providing a mold assembly which includes a first mold, a second mold, and an ejector, the first mold including a first base mold and a first core mold disposed in the first base mold, the second mold including a second base mold and a second core mold disposed in the second base mold, the ejector being disposed between the second base mold and the second core mold and surrounding the first base mold, the first core mold, the second base mold, the second core mold, and the ejector cooperatively defining a cavity;
(b) injecting a molten plastic material into the cavity followed by cooling so as to form the plastic lens;
(c) removing the first mold from an assembly of the plastic lens, the second mold, and the ejector; and
(d) moving the ejector relative to the second mold to move the plastic lens away from the second mold while maintaining the second core mold immobilized.

10. The method of claim 9, wherein the ejector has a tubular shape and a top end facing the cavity and abutting against the plastic lens, the top end having a thickness which is measured between an inner margin and an outer margin and which ranges from 0.20 mm to 0.25 mm.

11. The method of claim 9, wherein surfaces of the first base mold, the first core mold, the second base mold, and the second core mold that face the cavity are subjected to turning operation, and a surface of the ejector facing the cavity is subjected to plane grinding.
